(19) United States
(12) Patent Application Publication
(10) Pub. No.: US 2007/0017253 A1
(43) Pub. Date: Jan. 25, 2007

(54) Method for measuring the sagging of a glass panel to be bent on a ring mould

(76) Inventor: Toivo Janhunen, Kangasala (FI)

Correspondence Address: BUCHANAN, INGERSOLL & ROONEY PC, POST OFFICE BOX 1404, ALEXANDRIA, VA, 22313-1404, US

(21) Appl. No.: 10/558,750

(22) PCT Filed: Jun. 1, 2004
(86) PCT No.: PCT/FI04/50079

§ 371 Date: Dec. 1, 2005

(30) Foreign Application Priority Data
Jun. 2, 2003 (FI) 20035080

(51) Int. Cl. C03B 11/08; C03B 21/00

(52) U.S. Cl. 65/29.12; 65/107

(57) ABSTRACT

The invention relates to a method for measuring the sagging of a glass panel while bending the glass panel on a ring mould. Sagging is measured with a matrix camera and the measurement data is coupled to control the progress of a bending process, particularly the heating of glass or the abortion of a bending process. The ring mould can be provided with fixed pointers for facilitating a camera-operated measurement. In addition, at least one point on the glass surface, preferably between the pointers, is made visible to the camera.

The invention relates to a method for measuring the sagging of a glass panel while bending the glass panel on a ring mould.

More specifically, the invention relates to a method for measuring the sagging of a glass panel lying on a ring mould inside a bending furnace.

The ring mould method is particularly used for bending automotive windshields, but the method can be applied to the manufacture of other glass types, as well. The method comprises heating glass on top of a ring mould. When glass is set on top of a ring mould prior to bending, the sheet-like glass is in contact with the mould web typically at no more than 4-6 points but, upon bending, the glass descends to make contact with the ring mould over its entire outer periphery. When bending on a ring mould, glass is not supported at all in its mid-section, but just along the edges. By a proper application of heating energy, it is possible to achieve bending of the glass to a desired sag. The mould can also be hinged and equipped with counterweights, whereby it is easier to produce sharply bent shapes. Sagging has an effect on the practical performance of glass (e.g. distortions, operation of windshield wipers. Sagging has an effect also on the height dimension of glass as there is no significant elongation in glass, but mostly just deflection). At present, sagging is not measured by any device during a bending process, although this is done in final inspection. It is a major benefit to be able to measure sagging during a bending process, and to control or discontinue the bending as sagging develops.

It is an object of the invention to provide a method capable of realizing this advantage. This object is accomplished by the invention on the basis of characterizing features set forth in the appended claims.

The invention will now be described in more detail with reference to the accompanying drawings, in which

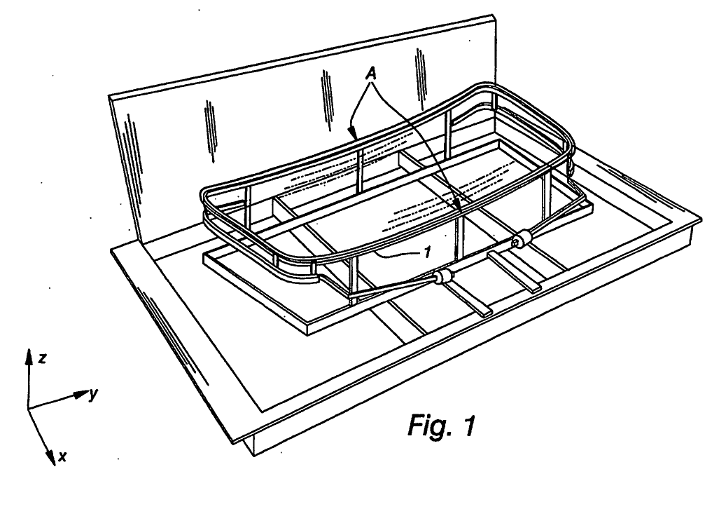

FIG. 1 shows a piece of glass on a ring mould, set on top of a mould carriage conveying the glass and the mould,

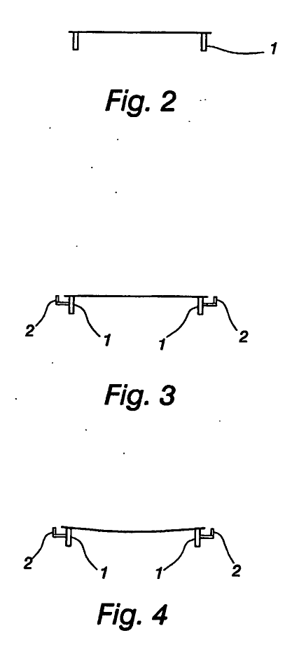

FIG. 2 shows a section of the glass on a ring mould, taken in a vertical plane extending by way of points A-A in FIG. 1. The cross-section is taken in the middle of the mould, and the figure is only drawn to depict a mould web and a piece of glass as the glass has not yet sagged but is already in contact with the mould web,

FIG. 3 shows the same as FIG. 2, but the mould is supplemented with fixed pointers (“feelers”) to facilitate imaging, and

FIG. 4 shows a piece of glass on a mould in sagged condition.

When this specification refers to a glass panel, it is equally well in reference to a pair of glass panels, consisting of two superimposed glass panels or sheets and having its glass panels bent at the same time.

The measuring method for sagging proceeds as follows.
1. A matrix camera is positioned at some 3D-point (e.g. the position of viewing FIG. 1), such that points A marked in the figure and the sagging of glass between the points A will be visible. A set of main coordinates X-Y-Z marked in FIG. 1 should be noted.
2. The visibility of points A in a mould 1 to the camera can be enhanced by supplementing the mould with fixed pointers 2 (“feelers”), i.e. painted bars of e.g. heavy-duty wire, which are bent beyond the glass area such that the elevation thereof is known (the elevation need not be level with the top surface of glass, because in that case the bars would hinder the settling of glass on the mould). See FIG. 3.
3. The following basic hypotheses are as follows
   An auxiliary set of coordinates is conceived, in which the X-axis extends via points A and the Y-coordinate retains its direction (Z-direction may change slightly from vertical, but has no significant practical effect on calculation). The set of auxiliary coordinates has its origin conceived at the mid-point between points A.
   The sagging in the middle of glass is now linearly proportional to the distance between the mid-point of glass and the origin of the set of auxiliary coordinates (if the feelers are placed at a level slightly lower than the top surface of glass, this must be taken into account).
4. The top surface of glass is extremely difficult for a camera to detect, and without auxiliary equipment it is almost impossible to distinguish e.g. said mid-point of glass. The mid-point can be made visible e.g.
   by placing a small firm pile of powdered siliceous earth at the mid-point of glass on top surface or between glass panels. This pile has no effect on the bending of glass, nor does it leave a mark on the glass (siliceous earth is commonly used in glass bending processes between superimposed glasses for keeping the glasses apart from each other to prevent the fusion thereof during a bending process), yet the pile is highly visible to a camera. It may also be acceptable to use a small clod of material in solid form, e.g. in the form of non-woven mat, which is used on the contact surfaces of hot glass. The auxiliary material may also be in the form of dots or drops.
   By applying plenty of siliceous earth between glasses or on the top surface of glass in a consistent layer, and by directing a laser beam through the roof of a furnace to the mid-point of glass, whereby the point is again highly visible to a camera.
5. During a glass bending process, the marked mid-point of glass moves in vertical direction only, normally it is not displaced at all in X- or Y-direction and thus, as the position of a camera is known, the measurement for the sagging of glass by the interpretation of a visual obtained by a matrix camera will be unambiguously successful.

The imaging can be performed by means of a regular matrix camera, e.g. with a resolution of 4096×4096 or 8192×8192. The camera can be positioned at any point, from which it has a clear visibility to the points A and the line of sagging (resolution in Z-direction). It is preferred that the camera be placed on the Y-axis of the auxiliary set of coordinates in vertical direction at such a distance above the level of glass that the deflected outer glass edge does not impede visibility to said points.

If it is desirable to monitor the line A-A for not only sagging in the middle but also for bending of other points, this can be done by marking the relevant points on glass the same way as the mid-point of the glass. The camera-reading program is required to know the location of points in the direction A-A.

If the geometry of a mould is known, it is possible to position points also elsewhere than on the line A-A, but in this case there must be some knowledge regarding mould geometry. By supplementing the mould with reference points (“feelers”), the monitoring can be performed by picking up extra points from line segments between these reference points, even without knowledge about mould geometry.

In practice, the camera can be mounted outside a furnace, behind a window made in a furnace wall (end or side wall) or roof.

If the furnace includes successive sections, as usual, there could be more space for a camera between the sections.

If necessary, a line camera can also be used for imaging glass on a moving carriage, by synchronizing the imaging with the motion and by producing a visual corresponding to a normal picture, the process being controlled on the basis thereof.

1. A method for measuring the sagging of a glass panel or two superimposed glass panels while bending each of the glass panels on a ring mould inside a bending furnace, said method comprising measuring the sagging with a matrix camera and having the measurement data coupled to control the progress of a bending process, particularly the heating of glass or the abortion of a bending process, wherein on a surface of the glass panel or between the glass panels is artificially made a point or points detectable by a camera and the camera is aimed directly towards the glass for detecting the point or points.

2. A method as set forth in claim 1 for measuring the sagging of a glass panel or two superimposed glass panels lying on a ring mould inside a bending furnace, wherein the round mould is provided with separate fixed pointers, facilitating a camera-operated measurement and having no effect on a bending process.

3. A method as set forth in claim 1 for measuring the sagging of a glass panel or two superimposed glass panels lying on a ring mould inside a bending furnace, wherein a point or points on the glass surface is made visible to the camera by placing on the surface of the glass panel or between the glass panels some material non-disturbing to a bending process in the form of a single pile, clod, dot, or drop.

4. A method as set forth in claim 1 for measuring the sagging of a glass panel or two superimposed glass panels lying on a ring mould inside a bending furnace, wherein a point on the glass surface is made visible to the camera by directing a laser beam to the point.

5. A method as set forth in claim 1, for measuring the sagging of a glass panel or two superimposed glass panels lying on a ring mould inside a bending furnace, wherein a point on the glass surface is made visible to the camera by placing on the surface of the glass panel or between the glass panels some material non-disturbing to a bending process in the form of an extensive area, and by directing a light beam or beams to this area.

6. A method as set forth, claim 2, wherein the camera is placed above the glass on an axis, whose direction is substantially transverse relative to a line segment between the pointers.

7. A method as set forth in claim 2 for measuring the sagging of a glass panel or two superimposed glass panels lying on a ring mould inside a bending furnace, wherein a point or points on the glass surface is made visible to the camera by placing on the surface of the glass panel or between the glass panels some material non-disturbing to a bending process in the form of a single pile, clod, dot, or drop.

8. A method as set forth in claim 2 for measuring the sagging of a glass panel or two superimposed glass panels lying on a ring mould inside a bending furnace, wherein a point on the glass surface is made visible to the camera by directing a laser beam to the point.

9. A method as set forth in claim 2 for measuring the sagging of a glass panel or two superimposed glass panels lying on a ring mould inside a bending furnace, wherein a point on the glass surface is made visible to the camera by placing on the surface of the glass panel or between the glass panels some material non-disturbing to a bending process in the form of an extensive area, and by directing a light beam or beams to this area.

10. A method as set forth in claim 4 for measuring the sagging of a glass panel or two superimposed glass panels lying on a ring mould inside a bending furnace, wherein a point on the glass surface is made visible to the camera by placing on the surface of the glass panel or between the glass panels some material non-disturbing to a bending process in the form of an extensive area, and by directing a light beam or beams to this area.

11. A method as set forth in claims 3, wherein the camera is placed above the glass on an axis, whose direction is substantially transverse relative to a line segment between the pointers.

12. A method as set forth in claim 4, wherein the camera is placed above the glass on an axis, whose direction is substantially transverse relative to a line segment between the pointers.

13. A method as set forth in claim 5, wherein at the camera is placed above the glass on an axis, whose direction is substantially transverse relative to a line segment between the pointers.
